(19) United States
(12) Patent Application Publication
(10) Pub. No.: US 2024/0067034 A1
(43) Pub. Date: Feb. 29, 2024

(54) SYSTEM AND METHOD FOR FACILITATING VEHICULAR-RELATED SERVICES

(71) Applicant: Reginald Hill Newkirk, Venice, CA (US)

(72) Inventor: Reginald Hill Newkirk, Venice, CA (US)

(21) Appl. No.: 18/457,643

(22) Filed: Aug. 29, 2023

Related U.S. Application Data
(60) Provisional application No. 63/402,505, filed on Aug. 31, 2022.

(51) Int. Cl. B60L 53/66; G08G 1/14

(52) U.S. Cl. CPC B60L 53/665; G08G 1/145; B60L 2240/60; B60L 2240/70

(57) ABSTRACT

A system and method can be used for finding available vehicular parking, providing a motorist with driving directions to a selected parking facility, and paying for the time that the vehicle remains parked in the facility without concern about a parking meter expiring or overpaying the meter.

The system and method can also be used to find and pay for other vehicular-related services, such as finding electric vehicle (EV) charging stations and paying for the EV charging cost, finding conventional gas station and paying for the fueling cost, and paying road tolls.

### CROSS-REFERENCE TO RELATED APPLICATION

This application claims priority under 35 U.S.C. § 119 to U.S. Provisional Patent Application No. 63/402,505, filed on Aug. 31, 2022, the disclosure of which is incorporated by reference herein in its entirety.

### TECHNICAL FIELD

The present invention relates to a system and method for facilitating vehicular-related services such as parking, fueling, tolls, etc.

### Discussion of the Related Art

Oftentimes, drivers need to park their vehicles in a location that requires payment for parking. Parking fees are typically based on time. This means that the longer one needs to utilize a parking spot the more the motorist will pay. The disadvantage with current payment practices is that the driver must estimate in advance how much parking time the driver needs.

Parking time estimations tend to be inaccurate. A disadvantage of underestimating one's time is that the parking meter will run out of time before the driver can return to remove the vehicle or pay for additional parking time. This, in turn, exposes the driver to the risk of receiving a parking violation for failure to feed the meter. A disadvantage of overestimating one's time is paying higher-than-necessary parking fees.

In addition, the act of stepping out of the vehicle and taking out one's wallet to feed the parking meter can increase the likelihood of falling prey to criminal activity in certain locations, and can also expose the driver to inclement weather.

Therefore, an improved vehicular payment method is needed.

### SUMMARY

The present invention relates primarily to an improved system and method for finding available parking, providing the motorist with driving directions to the selected parking facility, and seamlessly paying for the time that the vehicle remains parked in the facility without concern about the parking meter expiring or overpaying the meter.

This technology can also be utilized to find free parking spots in a desired location. In addition, the present invention can also be used to find and pay for other vehicular-related services, such as finding electric vehicle (EV) charging stations and paying for the EV charging cost, finding conventional gas station and paying for the fueling cost, and paying road tolls.

### BRIEF DESCRIPTION OF THE DRAWINGS

The above and other features of the present invention will become more apparent by describing in detail exemplary embodiments thereof in conjunction with the accompanying drawings, in which:

FIG. 1 is a diagram illustrating a system for paying for vehicular-related expenses according to an exemplary embodiment of the present invention;

FIG. 2 is a diagram illustrating the contents of a plurality of databases included in the system of FIG. 1; and

FIG. 3 is a perspective view illustrating a parking meter.

### DETAILED DESCRIPTION OF THE EMBODIMENTS

Exemplary embodiments of the present invention will be described more fully hereinafter with reference to the accompanying drawings. The present invention may, however, be embodied in different forms and should not be construed as being limited to the embodiments set forth herein. Like reference numerals may refer to like elements throughout the specification. The sizes and/or proportions of the elements illustrated in the drawings may be exaggerated for clarity.

When an element is referred to as being disposed on another element, intervening elements may be disposed therebetween. In addition, elements, components, parts, etc., not described in detail with respect to a certain figure or embodiment may be assumed to be similar to or the same as corresponding elements, components, parts, etc., described in other parts of the specification.

The present invention is primarily directed to an improved system and method for finding a suitable parking spot and paying for the spot. The present invention separates its participants into three groups. Group one includes persons seeking to find a parking spot for their vehicles. These persons are generally referred to as “users” or “drivers” in this specification. Group two includes the entities that provide access to parking facilities and other services for the users. These entities are generally referred to as “providers” in this specification. Group three includes enforcement authorities that can verify that a parked car is actually paying for its parking time.

Both drivers and providers register with the system of the present invention. The drivers provide information about themselves and their vehicles. For example, a driver can indicate whether the driver has any special attributes (such as being an emergency worker, meaning that the driver is allowed to park in a spot reserved for emergency vehicle operators only), the size, weight, etc., of the vehicle in order to determine whether the vehicle can fit in a certain parking facility (or parking spot), etc.

The providers enter information about their parking facilities, such as the address of a parking facility, the number of vehicles that the facility is designated to accommodate, restrictions of the parking facility (e.g., no vehicles taller than a certain height or no vehicles above a certain weight), and a fee schedule for the parking facility, indicating with particularity how much it costs to park in the facility. The parking facility can be street parking, an above-ground parking lot, a parking garage inside of a building, etc.

New providers can be registered continuously in order to increase the number of services available to the drivers. New drivers can also be continuously registered in order to take advantage of the services provided by the providers.

The present invention provides its drivers with a software that allows them to search for a parking spot in a desired location. The software can be, for example, an app running on a user's mobile device. The app is configured to interface with a backend server in order to transmit the user's search request for available parking locations to a backend server, and to display the available results that the backend server finds based on the user's search requirements. When a driver selects a parking facility of his or her choice, the app can provide the driver with driving directions to the facility.

The driver's entry into a parking facility can be determined in one or more of several methods. These methods include GPS tracking of the user's vehicle and scanning a transponder attached to a vehicle at an entrance of the facility.

Once that a driver enters a parking facility, the driver agrees to pay for the entire time that the vehicle will remain parked in the facility. This can be done either automatically or manually upon entering the facility. This is advantageous because it eliminates the prior art problem of receiving a parking violation for an expired meter (when the meter expires before the user can return to pay for additional time or remove the vehicle) since the user is “on the clock” the entire time that the vehicle remains parked.

When the driver exits the parking lot, the total parking time will be determined based on the entry time, and the driver will be billed accordingly.

A parking enforcement agent can use a handheld (or mobile) device to interface with the server of the present invention to confirm that a parked car is actually paying for its time.

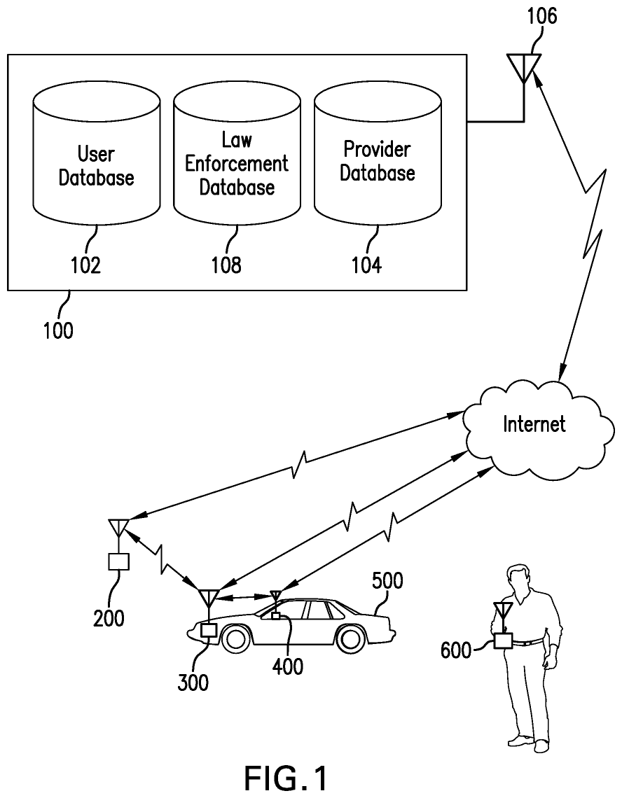

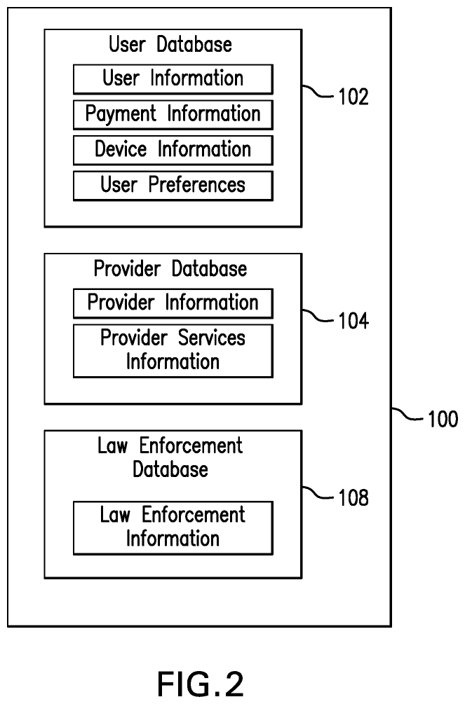

These features and advantages of the present invention will now be described in more detail below with reference to FIGS. 1 and 2.

Referring to FIG. 1, a system for facilitating vehicular-related services includes a server 100 (or other type of computing device such as a workstation, a mainframe, etc.), at least one fixed device 200 installed at a parking facility, and one or more mobile devices 300 and 400 associated with a user's automobile 500, and a mobile device 600 used by an enforcement agent to verify that parking is being paid for. As illustrated in FIG. 1, the server 100 and devices 200, 300, 400 and 600 can be communicatively coupled to one another wirelessly via the internet. However, these components can also be communicatively coupled to one another via other wireless communication methods, including, for example, Bluetooth, Wi-Fi, cellular bands, etc., or via a wired connection.

As illustrated in FIG. 1, the server 100 includes a user database 102, a provider database 104, a law enforcement database 108 and a transceiver 106 for communicating with the devices 200, 300 and 400.

Referring to FIG. 2, the user database 102 includes information about each user of the system of FIG. 1, information about the vehicle(s) of each user, information concerning payment method(s) that each user wishes to utilize to pay for expenses related to the use of use each vehicle that the user owns or operates, information about the devices 300 and 400 associated with each user, and information about user preferences.

The information about each user may include, for example, the user's name, address, and contact information (e.g., a telephone number, email address, etc.). The information about the user may also include whether the user has any special attributes, for example, whether the user is an emergency worker (which would enable the user to park in locations reserved for emergency workers only), whether the user is a teacher (which would enable the user to park in locations reserved for teachers only), etc.

The information about the vehicle(s) of each user may include the license plate number, make, model, color, vehicle identification number (VIN), number of axles, gross vehicle weight, length, width and height of the vehicle (which can be used to determine whether the vehicle can enter in a multistory parking garage with low ceilings, or other parking facility with a low overhead clearance), etc., for each vehicle 500 that is associated with each user. Association, in this case, means that the vehicle is driven or operated by the user.

The payment information for each user may include, for example, credit/debit card information, a bank account number for ACH and wire transfers, cryptocurrency wallet information in order to pay via cryptocurrency, etc. This information can be used to bill a user for vehicular-related expenses such as parking the user's vehicle in a parking facility, charging the user's vehicle in an electric vehicle (EV) charging station, fueling the user's vehicle at a gas station, etc.

The devices 300 are mobile tracking devices that are attached to the user's vehicles. Each mobile device 300 may be reachable by the user from the interior of a vehicle or may be non-reachable by a user (e.g., installed at a location of the vehicle that is not readily reachable by a person sitting on the driver's seat). Each vehicle 500 of each user has its respective device 300 attached thereto for tracking the location of the vehicle. In other words, each device 300 is linked to a particular vehicle of a registered user in the user database 102.

Each mobile device 300 may include, for example, a housing with a GPS and/or GLONASS sensor, a transponder configured to indicate a predetermined device ID in response to an incoming wireless read signal, a transceiver for receiving requests for information (such as GPS location data) from the server 100 and for broadcasting to the server 100 GPS/GLONASS sensor data.

A conventional GPS receiver can be incorporated in the mobile devices 300 and/or 400 (described below), in order to obtain GPS location data of the device 300 or 400, as the case may be, from GPS satellites. The GPS data may then be transmitted to the server 100 via the transceiver of the device 300, 400.

Each device 300 may also include an internal power source (e.g., a battery), or may be connected to an external power source to power the GPS/GLONASS sensor (hereinafter “GPS” sensor for brevity) and the transceiver.

Each mobile device 300 may be embodied as a purpose-built device that includes the components described in this specification in order to operate as described in this specification. In addition, or alternatively, a smartphone, tablet, or similar mobile device may be utilized to operate as the mobile device 300. Furthermore, older mobile devices (such as flip phones, brick-like phones, etc.) can be modified to operate as the mobile device 300.

The server 100 is configured to communicate with each device 300 of each vehicle of each registered user in real-time or at predetermined time intervals (e.g., every 5 seconds, every 30 seconds, every minute, every five minutes, etc.) in order to retrieve GPS sensor data from each device 300.

The devices 200 are tracking/monitoring devices that may be fixed at parking lot entrance(s) and exit(s) in order to identify and track each vehicle of each user that enters and exists each parking lot (or parking facility) In some instances, such as in paid street parking facilities that have no designated entrance and exit lanes, an individual device 200 may be installed in each parking spot in the facility in order to identify the vehicles parked in the facility and to keep track of the number of vehicles parked in the facility.

Each device 200 may include a housing with a transceiver inside that is configured to wirelessly detect the presence of a vehicle by, for example, using Bluetooth, RFID, or other wireless communication protocol to communicate with the transponder of the device 300 that is associated with a vehicle being detected. The device 300 is identified when its device ID is read from the transponder, which, in turn, identifies the vehicle being associated with the device 300 and the owner/operator of the vehicle.

Alternatively, or in addition, each device 200 may include a camera that is configured to continuously or intermittently capture image data in order to capture the license plate information of each vehicle that drives near it. The server 100 can compare the license plate information from the captured images with the license plate information of the users contained in the user database 102 to determine the specific vehicle and owner/operator associated with the vehicle that is either entering a parking facility to park inside, or is exiting the parking facility.

Each device 200 in each parking facility may be communicatively coupled with the server 100 via a wireless or wired connection in order to transmit the data that it captures from users' vehicles to the server 100. For example, each device 200 may be configured to transmit the transponder readings from each vehicle that comes within range of the device 200 and every image of every license plate that it captures in real-time, or at predetermined time intervals.

An individual device 200 can also be included in each parking spot of a parking garage or any other parking facility to determine whether each parking spot at each facility is available or occupied by a parked automobile. Each device 200 may be used to determine the status of each parking spot (e.g., whether each individual spot is available or occupied by a vehicle) by, for example, using the camera provided in the device 200. Each device 200 may also include a proximity sensor to determine whether a particular parking spot is available or occupied. The device 200 may be configured to use the camera alone, the proximity sensor alone, or the camera and proximity sensor in combination with one another in order to determine whether a particular parking spot in a parking facility is available or not. This information may be transmitted to the server 100 in order for the server 100 to keep an up-to-date account of parking availability at each parking facility. Therefore, each user of the system and method of the present invention can be informed in real-time whether a parking facility at a location the user desires to travel to will be able to accommodate the user's vehicle.

Each device 400 may be, for example, a purpose-built device that includes the components described in this specification in order to operate as described in this specification. In addition, or alternatively, each device 400 may be embodied as, for example, a smartphone, a tablet, a laptop, or other mobile device that can be configured to perform the functions of the device 400 as described in this specification. Furthermore, other known types of mobile devices can be modified to perform the functions of the mobile device 400 as described in this specification.

The device 400 may include an application software installed which enables the user to interface with the server 100. Therefore, the device 400 is preferably located in an area of the cabin that is easily reachable and viewable by the user (or driver) of the vehicle. The device 400 enables the user to create a new user account, input all the data describing the user and describing each vehicle that the user registers to use with the system of FIG. 1, enables the user to set and change user preference data (described below), to view user account activity (including services used and their associated costs) for each vehicle associated with the user, and optionally, to manually approve charges for new activities as they occur (e.g., to approve a request to make payment for a parking facility that the user is driving in when the user indicates in his/her preferences that the user wishes to manually approve such charges).

The user preferences data may include, for each user, information indicating the user's preferred payment method (e.g., the user prefers to pay by a credit card but if the credit card transaction is declined then pay by a wire transfer, cryptocurrency, or other backup/secondary means of payment indicated by the user). The user preferences data may also include information indicating whether the user wishes to automatically approve each new transaction as it occurs (e.g., to automatically approve the parking fees of a certain facility when the user drives into the parking facility), or whether the user prefers to approve such transactions manually.

As a backup, if all other payment methods on file fail for a particular user, the server 100 can be configured to issue the user a bill by mail. The advantage of this approach is that the user will be deemed (or marked) as being “on the clock” while using a given parking facility (especially one that requires payment for parking), accruing time as if the payment was pre-authorized, and therefore, will not receive a parking violation for an expired or unpaid meter from law enforcement while using the parking facility.

In addition, each device 400 may also include a GPS sensor, and may be configured to transmit the GPS location data of the device 400 to the server 100 in real-time or at predetermined time intervals. In other words, each device 400 (and each device 300) can be used to track the location of each user while driving.

A provider, as referred to in the provider database 104, can be a governmental entity, a private entity, or other entity that provides parking services for the vehicles of the users included in the user database 102. In addition to parking services, a provider may also offer electric vehicle (EV) charging station(s), gas station(s), toll plazas, etc.

Referring to FIG. 2, the provider database 104 may include, for each provider, the type of provider (e.g., a governmental or a private entity), the provider's name, provider address, and type of service(s) provided (e.g., vehicular parking, EV charging, etc.).

For each service provided by each provider, the database 104 may include information indicating the location of a particular facility, the services provided by the facility, the qualifying criteria for utilizing the facility, and a fee schedule for using the facility.

As indicated above, the types of services offered by each entity may include at least one selected from the group containing parking services, whether on-road or in a parking lot/facility, EV charging, fueling, and road tolls.

For each service offered by each provider, the database 104 may contain information pertinent to the type of service.

For example, when the facility is a parking location (whether on-street parking, or a parking lot) the information, the database 104 may include a general description of the facility, an address of the parking location, a geofence of the parking facility, the total number of parking spots in the facility, including a count of currently occupied spots and a count of currently available spots, which can be determined based on information received from the device(s) 200 at each facility as described above, qualifying criteria for the user and/or vehicle to park in the facility, and a fee schedule for the parking facility.

As an example, the description of a certain parking facility in the database 104 may indicate that the facility offers street parking, that one of the sides of the street has a certain amount of total parking spots, that a particular number of these spots are available, and that the rest of the spots are occupied by other cars. The description of the facility may also indicate the cost to park at the facility (as provided by the provider of the parking facility), and requirements to park there (e.g., passenger vehicle parking only, no trucks, no overnight parking or overnight parking allowed, etc.). The description of the facility may also include a geofence of the facility.

When the facility is an EV charging station, the database 104 may include a general description of the facility, an address of the facility, a geofence of the facility, the total number of charging stations in the facility, including a count of currently occupied stations and a count of currently available stations, types of charging stations (e.g., plug-in-style charging stations where the user picks up a charging cable from the station and plugs it into the user's car, or wireless charging stations, determined by using the devices 200 as described above for parking facilities, where an electric cable would be coiled onto or under the surface of the pavement in order to wirelessly charge a vehicle parked above the coil (a vehicle that supports wireless charging)), charging capability information for the type of the charging station, charging plug requirements at each plug-in-style station, wireless charging requirements at each wireless charging station, and a charging cost (typically in cents per kWh).

The present invention can also be used to automatically or manually pay for electricity used by a traveling vehicle that is connected to an electric power source while the vehicle is moving. This scenario applies to electrified roadways, such as, for example, a particular freeway in Germany where a portion of the freeway includes electric lines extending along the length of the roadway above the vehicles, and trucks or other vehicles have an extendable electrical connector that protrudes upwardly from the top of the vehicle and connects the vehicle to the electric lines above in order to electrically power the vehicle. In this case, the vehicle may have an electric meter inside measuring how much electricity the vehicle consumes while traveling. The mobile device 300 and/or mobile device 400 may be communicatively coupled to the electric meter of the vehicle, and may automatically or manually pay for electricity used by the vehicle (by reading the meter and paying per the consumed electricity at the rate per kWh specified by the electric provider), when the vehicle exits the electrified portion of the road, when the vehicle is turned off, at predefined time intervals, etc., by communicating with the sever 100 to make the payment. This would do away with the necessity of having a meter inspection agent visit each electric vehicle to determine the amount of electricity used by each vehicle. Alternatively, or in addition, the consumption of electricity in such cases can be estimated by taking into account the weight of the vehicle, the speed of the vehicle (tracked by the GPS sensor of the device 300 and/or 400), and the distance traveled by the vehicle (also tracked by the GPS sensor of the device 300 and/or 400). The estimated electric usage may then be paid for as described above.

Toll plaza facilities may include the cost to utilize the toll road, which may depend on the time of day (e.g., rush hour cost versus off-peak cost), cost per type of vehicle (e.g., passenger vehicles typically pay a smaller fee than commercial trucks, vehicles that have three or more axles, etc.).

In the case of parking facilities that are parking lots (as opposed to street parking), each parking lot of each provider may include one or more tracking devices 200 installed at or adjacent to entryway(s) and exit lane(s) of the lot for detecting and identifying users' vehicles that enter the parking lot (with an entry timestamp created when entering), and detecting and identifying users' vehicles that exit the parking lot (with an exit timestamp when exiting).

For example, when a user drives a vehicle into a parking lot through an entrance of the lot, a tracking device 200 installed near the entrance lane identifies the transponder ID of the device 300 associated with the vehicle at an entrance of a parking facility. In this case, the server 100 determines which vehicle of which user is entering the parking facility (by matching the transponder ID read by the device 200 at the entrance with the transponder IDs associated with the users in the user database 102), and creates an entry timestamp for the vehicle at the parking facility that the tracking device 200 is associated with. The server 100 is configured to update the number of available parking spots at the parking facility by one in order to account for the vehicle that entered.

When a user drives the vehicle out of the parking lot at a later time, a second tracking device (installed adjacent to an exit lane of the parking facility) identifies the transponder ID of the device 300 associated with the user's vehicle. The server 100 creates an exit time stamp, and bills the user for the duration of parking time between the entry and exit timestamps in accordance with the fee schedule of the particular facility where the user parked.

In parking lots that have only one lane for both entry and exit, one device 200 can be installed adjacent to the entry/exit lane to track the vehicles entering and exiting the lot. For example, when the device 200 reads the transponder ID of a particular vehicle the first time, the server 100 can be configured to interpret the reading as indicative that a particular vehicle has entered the parking lot. When the device 200 reads the same transponder ID at a later time, the server 200 can be configured to interpret the reading as indicative that the vehicle has exited the lot.

In a different approach, each parking spot within a particular parking facility (whether on street parking or a parking lot) has a separate device 200 installed at or adjacent to each individual parking spot inside of the facility. In this case, the camera of the device 200 at each parking spot within the facility may be configured to capture images of its parking spot continuously or at predetermined time intervals (e.g., once a minute, every five minutes, etc.). These images can be used to detect the presence of a vehicle in a parking spot, identify the vehicle being parked as one belonging to a registered user by comparing the license plate information retrieved by the image data with the records in the user database 102, determining an incoming time stamp (e.g., based on when the vehicle was first detected), and determining a departure time stamp (e.g., when the vehicle leaves the parking spot and is no longer detected by the monitored image data). The incoming and departure time stamps may also be used to update the number of available parking spots for other users (who may wish to park in this location) to see in real-time.

In yet another approach, the geofence of a parking facility can be used to determine that a user's vehicle has parked at a particular parking facility, that a user's vehicle has exited the parking facility, and to update the number of available parking spots at the facility in real-time.

In the geofence approach, a vehicle is identified as entering a parking facility when the GPS sensor data that is obtained from the device 300 of a vehicle indicates that the location of the vehicle falls within the geofence of the parking facility.

When a vehicle is identified as entering the geofence of a parking facility, the server 100 creates an entry timestamp for the vehicle and reduces the number of available parking spots at the facility by one.

The GPS location of the device 300 of the vehicle can be monitored as indicated above to determine when the vehicle exists the parking facility (e.g., when the GPS data indicates that the device 300 has traveled outside of the geofenced location). This creates an exit timestamp for the particular vehicle being tracked, and increases the number of available parking spots at the facility by one. The server 100 will then determine the amount of time that the vehicle was parked and the parking cost as indicated above.

The geofence approach described above is best suited in areas where the parking facility receives strong GPS signal. This enables reliable tracking of the GPS sensor of each device 300 of each vehicle that is located inside and/or in the vicinity of the parking lot. For example, above-ground one-story parking lots in areas that are away from tall buildings or tall trees generally receive strong GPS signal. In such facilities, the tracking of vehicles parked in the facility can be done via GPS only in order to eliminate the costs associated with installing and maintaining the tracking devices 200.

As can be appreciated, the use of devices 200 for determining parking occupancy and availability may be preferred in locations that receive weak or no GPS signal. These include, for example, underground parking lots and parking facilities that are located around or inside tall buildings (which may affect GPS accuracy). In addition, the use of devices 200 for determining parking usage may be preferred in a building that contain two or more different parking lots located on different floors (in order to determine which facility/floor the user has parked in), and in parking lots that charge different fees for parking on different floors (in order to track which floor a particular car is parked in).

In some cases, the different approaches described in this specification can be used in combination with one another to determine the number of available parking spots at each parking facility, to determine the location and particulars (e.g., parking restrictions or limitations) of each available spot and of each occupied spot at each parking facility, to determine when a user enters and exits a parking facility, and to determine the particular spot that a user occupies at a given parking facility.

In one approach, a device 300 and a device 400 can be used in combination with one another to find a desired parking spot, obtain driving directions to the parking spot, and determine that the vehicle carrying the devices 300 and 400 has entered the desired parking structure (and determine the particular parking spot occupied by the vehicle when the parking facility includes an individual tracking device 200 at each parking spot). In this approach, it is advantageous to utilize the device 300 to track the location of the vehicle and/or to identify the vehicle (whether by the geofencing method and/or method that utilizes the tracking devices 200), and to separately utilize the device 400 (e.g., a smartphone, tablet, or the like) for communicating with the server 100 in order to search for suitable parking spots and/or parking facilities and provide the user with driving directions to a particular parking facility. The use of the devices 300 and 400 for separate tasks avoids the confusion that may arise when otherwise using the mobile device 400 (which may be the user's smartphone) for tracking the location of the user's vehicle as well in instances when the user will carry the mobile device 400 on the user's person when exiting the parking facility (with the vehicle remaining parked in the facility), which can be mistakenly interpreted as the user's vehicle having exited the parking facility.

The devices 600 are mobile devices that law enforcement agents can use to verify that parked vehicles are paying for their parking time (i.e., that they are properly parked). The mobile devices 600 may have an application software installed that is configured to upload to the server 100 some identifying data of a vehicle in question, for example, the VIN number, the license plate number, etc. The server 100 identifies the vehicle based on the information received from the mobile device 600, and transmits to the mobile device 600 a message indicating whether the vehicle is paying for parking or not.

Referring to FIG. 2, the law enforcement database 108 may include information about law enforcement agencies/agents that are registered to access the server 100 in order to verify the status of a parked vehicle.

The user database 102, the provider database 104 and the law enforcement database 108 are exemplarily illustrated in FIG. 1 as being separate databases within the server 100. However, the present invention is not limited to the configuration. For example, all of the information included in the user database 102, the provider database 104 and the law enforcement database 108 can be stored in a single database within the server 100. Alternatively, or in addition, all of the information included in the user database 102, the provider database 104 and the law enforcement database 108 can be stored in two databases, or in more than three databases, as desired.

The system described above can be used to overcome the disadvantages of the prior art. Particularly, the parking system and method of the present invention can be utilized to prevent users from receiving parking violations that result from underestimating parking needs in advance (which will cause the meter to expire before the user can return to feed the meter again or remove the vehicle). This is so because, in the present invention, the meter is running (i.e., accruing time) when a vehicle is parked in a facility.

In addition, the present invention does away with overpaying for a parking spot, as is commonly done in the prior art, since users no longer need to overestimate their parking time in order to avoid having the meter expire before they return to the vehicle.

A method of the present invention includes utilizing the system of FIG. 1 to provide users with available parking in a desired location, to provide users with driving directions to the parking location, to accrue parking time when a user enters a parking facility, and to bill the user only for the time spent parked when users exit the parking facility.

The first step in the method of the present invention may include receiving a search inquiry from a user. The user may search, for example, for a parking spot in a desired area that the user wishes to visit. The user can perform the search via the app that is installed in the user device 400.

For example, a particular user may desire to drive to a distant shopping mall. Therefore, the user needs to park the car at or near the mall. In this case, the user enters the address of the shopping mall in the device 400, and the server 100 may indicate, as an example, that the shopping mall in question has a parking facility with a certain number of available parking spots. The server 100 may also indicate that some of the available parking spots in the mall are free of charge, and others require a fee.

The method may also offer to provide the user with driving directions to the mall parking facility.

Optionally, in response to a user indicating a desire to park at a particular parking facility (such as the one the user desires to obtain driving directions to), the method may include determining whether the user and/or user's vehicle do not qualify to park at the location for certain reasons. For example, some parking lots have restrictions on the height of a vehicle due to low ceilings. In other cases, a stretch of a particular on-street parking area adjacent to a medical facility may be designated by the local municipality as parking for ambulances or emergency vehicles only.

In the case above, the method may include comparing the height of the roofline of the user's vehicle (indicated in the user database 102), with the maximum vehicle height allowed in the parking lot (indicated in the database 104) in order to determine whether the user can enter the parking facility. In the case of the street parking that is designated only for emergency vehicles, the method may include reviewing the user database 102 to determine whether the particular user who seeks to park there is identified as an emergency operator and/or whether the vehicle that the user is driving is identified as an emergency vehicle.

When the driver and/or vehicle do not qualify to park at the selected facility, the method may include indicating to the driver (via a message displayed on the screen of the user's device 400, by a text message, a voice message, etc.) that the user cannot park at the selected facility along with the reasons why.

When the driver and/or vehicle qualify to park at the selected facility, the method may then generate driving directions to the facility based on the GPS location of the user (obtained via the GPS sensor of the user's mobile device 400 and/or via the GPS sensor of the user's device 300 that is installed in the vehicle).

When the driver qualifies to park at the facility and follows the driving directions to the facility, the user may enter the facility and park at one of the available parking spots. In the example above with the shopping mall, the user may enter the parking facility and elect to park in a fee-based spot or at a free parking spot.

Alternatively, when the user is familiar with the parking facility, the user may simply drive the vehicle inside of the parking facility without obtaining driving directions thereto (whether the parking facility offers paid parking or free parking).

The user's entry into the paid area of a parking facility (or into a particular paid parking spot) can be determined as described above.

When the user enters a paid parking lot, as in the shopping mall example above, or parks in a street location that requires fees, the method may include reviewing the user preferences to determine whether the user has indicated a preference to automatically approve parking fees or whether the user wishes to manually approve parking fees.

When the user has indicated a preference to approve all parking fees automatically, the method includes the step of beginning to accrue parking time for the user's vehicle and to reduce the number of available paid parking spots at the facility.

When the user has indicated a preference to approve all parking fees manually, the method includes the step of requesting the user to approve the parking fee that will accrue for parking at the selected location.

When the user indicates approval to pay, the method includes beginning to accrue parking time for the user's vehicle and to reduce the number of available paid parking spots at the facility.

When the user refuses to pay, the method may include indicating to the user that the user may not park in this parking facility.

When the user elects to park in a free parking spot, such as in the free area of the parking lot of the shopping mall in the example above, method may include the step of beginning to accrue parking time for the user's vehicle (for record-keeping purposes) and to reduce the number of available paid parking spots at the free parking facility by one.

In the paid parking scenario, when the user approves the parking charges (either automatically or manually), the method includes setting (or registering) the status of the vehicle as properly parked (or, in good standing). Therefore, when a local parking enforcement agent (in the case of paid street parking, as an example) checks the street for parking violations, the method of the present invention includes indicating to the enforcement agent that the vehicle which the agent is inquiring about is properly parked (and paying for parking time).

For example, the enforcement agent may scan the VIN number of the vehicle in question, or may input the license plate number of the vehicle in question via a handheld mobile device that is communicatively coupled with the server 100. The server 100 would respond by indicating that the vehicle is properly parked. Therefore, the enforcement agent cannot issue a parking violation for failure to paying the meter.

When the user leaves the parking facility, an exit time stamp is created for the particular vehicle as described above. The total parking time is determined by comparing the entry time stamp with the exit time stamp. The user is billed for the entire duration of parking time in accordance with the fee schedule of the particular facility where the user parked.

The system and method of the present invention is particularly advantageous in correcting the shortcomings in the prior art that require a motorist to estimate in advance how much parking time is needed in a public (or private) parking location that requires payment. For example, the present invention can prevent a parking violation that is likely to issue when a motorist allows a parking meter to expire due to an appointment that takes longer than initially estimated. For example, it is not reasonable to expect a motorist to leave a dentist's chair in the middle of a dental procedure in order to feed a parking meter that will soon expire, or has just expired, due to the dental appointment taking longer than initially estimated. In such a case, it appears unfair to issue the motorist a parking violation.

In the present invention, this scenario is prevented because the meter is running (or accruing time) as the vehicle is parked, and the user has agreed upfront to pay for the entire time that his/her vehicle remains parked. The approach of the present invention is beneficial for the user (avoiding parking violations that can result from the meter expiring), and for the municipality (prevents losses resulting from unpaid parking time that motorists get away with by driving away prior to receiving a violation for parking in an expired meter).

In addition, the present invention is advantageous in that it can prevent the user from being exposed to inclement weather in some cases. For example, when a user needs to park in an open-air parking facility but wishes to remain inside of the vehicle during the time that the car is parked (e.g., the driver is taking a break, waiting for a delivery, etc.) the driver can be spared from being exposed to the elements since the user no longer needs to walk to the parking meter in order to pay for the parking spot.

The server 100 may include a processor and a non-transitory, tangible program storage medium embodying a program of instructions executable by the processor to perform the method steps described in this specification for facilitating the process of finding available parking spaces in parking facilities, EV charging locations, gasoline stations, etc., and paying for the costs incurred at the respective facilities/locations/stations. The program of instructions may also include method steps for paying for electricity consumed during a trip as described in this specification.

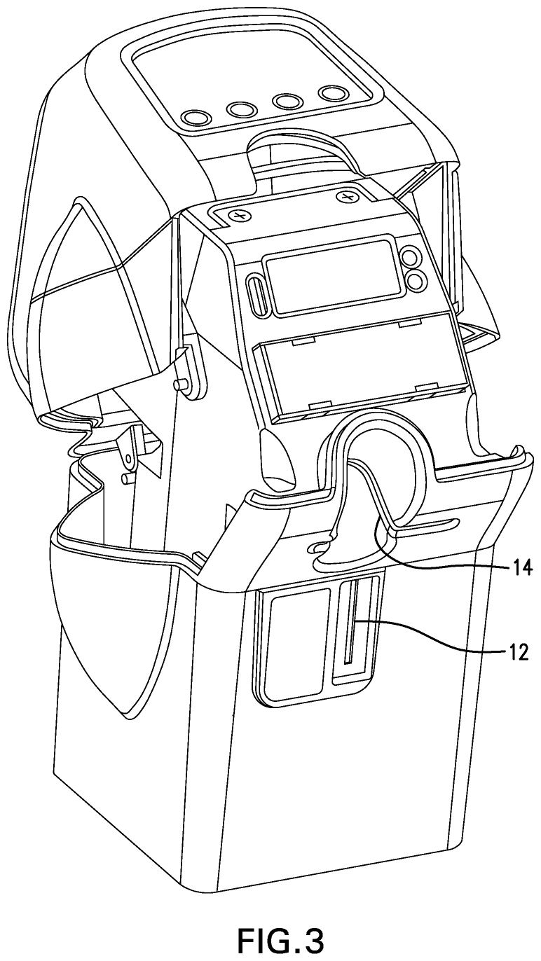

FIG. 3 illustrates a known type of parking meter, as described in U.S. Patent Application Publication No. 2011/0203901. Such known technology requires a driver to exit the vehicle in order to walk to the meter to feed it by either inserting coins into the meter or feeding a credit card into a slot of the meter. When such a meter is parked in outdoor areas, the user may get soaking wet, cold, hot, muddy, etc., depending on the weather, when walking from the vehicle to the meter. The present invention, as described above, does away with this type of parking meter and the inconveniences that it can cause to drivers.

However, the parking meter of FIG. 3 can be modified, for example, to serve as the device 200 described in this specification. This can be accomplished, for example, by removing the coin slot 12 and credit card slot 14 from the meter of FIG. 3 (such that the user no longer needs to interact with the meter by feeding it), and modifying the meter to include the transceiver of device 200, the camera of the device 200, the proximity sensor, and all other hardware components of the device 200 described in this specification. Such a modified meter can be used in the present invention to detect the presence of vehicles entering and exiting a parking facility via its transceiver and/or camera, how long the vehicles remain parked in the facility (via the transceiver and/or camera), etc. As described in this specification, the modified device of FIG. 3 can also be used to detect the presence or absence of a vehicle in an individual parking spot within a parking facility. The modified meter can relay this information to the server 100 via its transponder such that each user can be billed accordingly.

The modified meter of FIG. 3 can also be used to pay for other vehicular services, such as EV charging costs, the cost to fill up at a conventional gas station, etc.

The present invention can also reduce crime in certain locations where the act of taking out one's wallet to pay for the parking meter—as is done in the prior art—can induce a third party to rob the driver.

The technology described above can also be applied to finding EV charging stations, paying for electricity consumed at the EV charging station (to charge the user's electric vehicle), to pay for fuel costs at a conventional gas station, to pay for road tolls, etc.

While the present invention has been particularly shown and described with reference to exemplary embodiments thereof, it will be apparent to those of ordinary skill in the art that various changes in form and detail may be made therein without departing from the spirit and scope of the present invention.

What is claimed is:

1. A system for facilitating vehicular parking, comprising:
a processor;
a server including a database, the database including information about a plurality of vehicles, information about a plurality of users associated with the vehicles, and information concerning a parking facility, the information concerning the parking facility including a geofence of the parking facility;
a plurality of mobile devices associated with the plurality of users and with the plurality of vehicles and respectively disposed on the plurality of vehicles, each of the mobile devices including a GPS or GLONASS location sensor and being configured to receive location data from said location sensor, the location data of each of the location sensors being indicative of a location of the respective vehicle on which the sensor is disposed; and
a non-transitory, tangible, program storage medium, readable by the system for facilitating vehicular parking, embodying a program of instructions executable by the processor to perform method steps for facilitating vehicular parking, the method comprising:
monitoring location data from a first mobile device from among the plurality of mobile devices;
comparing the monitored location data with the geofence of the parking facility and determining that a first vehicle associated with the first mobile device has entered the parking facility when the monitored location data plots within the geofence;
accruing parking time for the first vehicle while the monitored location data continues to indicate that the first vehicle remains inside of the geofence;
marking the first vehicle as currently paying for parking for law enforcement purposes while accruing parking time;
determining that the first vehicle exits the parking facility when the monitoring of the location data indicates that the first mobile device exits the geofence;
stopping to accrue time when determining that the vehicle has exited the parking facility;
determining a parking amount owed by the user associated with the first vehicle for utilizing the parking facility based on the accrued time; and
billing said user for the amount owed.

2. The system of claim 1, wherein the user database includes at least one payment method authorized by the user to be utilized for paying for parking related fees, and wherein the method step of billing the user includes charging the amount owed to the at least one authorized payment method.

3. The system of claim 1, wherein the user database includes a billing address for the user, and
wherein, when the step of charging the amount owed to the at least one authorized payment method results in no payment collected, the method further includes the step of billing the amount owed to the user's billing address.

4. The system of claim 1, wherein the first mobile device is attached to the first vehicle at a location of the first vehicle that is not within a reach of the user from a driver's seat of the first vehicle.

5. The system of claim 1, wherein the method further includes prompting a user of the first vehicle whether the user wishes to obtain driving directions to the parking facility, and
in response to an affirmative indication by the user, obtaining driving directions for the user to follow to the parking facility.

6. The system of claim 1, further including a second mobile device disposed on the first vehicle and associated with the first vehicle,
wherein the method further includes prompting a user of the first vehicle whether the user wishes to obtain driving directions to the parking facility, and
in response to an affirmative indication by the user, obtaining driving directions for the user to follow to the parking facility and displaying said driving directions on the second mobile device.

7. The system of claim 6, wherein the second mobile device is a smartphone.

8. The system of claim 1, wherein the method further includes prompting a user of the first vehicle whether the user wishes to park in the parking facility; and
in response to an affirmative indication by the user, comparing information about the parking facility with information about the first vehicle;
determining that first vehicle is of a size or type that can be parked in the parking facility based on the comparison;
obtain driving directions to the parking facility, and
presenting the user with said driving directions.

9. A system for facilitating vehicular parking, comprising:
a processor;
a server including a database, the database including information about a plurality of users, a plurality of vehicles associated with the users, and a parking facility including a first parking spot and a second parking spot;
a first tracking device installed at or near the first parking spot and configured to detect the presence of a vehicle in the first parking spot, and a second tracking device installed at or near the second parking spot and configured to detect the presence of a vehicle in the second parking spot; and
a non-transitory, tangible, program storage medium, readable by the system for facilitating vehicular parking, embodying a program of instructions executable by the processor to perform method steps for facilitating vehicular parking, the method comprising:
receiving a first set of data from the first tracking device;
analyzing the first set of data to determine that a first vehicle from among the plurality of vehicles occupies the first parking spot;
starting to accrue time that the first vehicle remains in the first parking spot;
marking the first vehicle as currently paying for the first parking spot for law enforcement purposes;
receiving a second set of data from the first tracking device and determining based on the second set of data that the first vehicle has departed the first parking spot;
stopping to accrue time for the first vehicle;
determining an amount owed by a user associated with the first vehicle, from among the plurality of users registered with the database, for utilizing the first parking spot for the accrued time; and
billing said user for the determined amount.

10. The system of claim 9, wherein the tracking device includes a camera configured to capture image data of the first parking spot, and
the first set of data received from the tracking device includes an image of the vehicle occupying the first parking spot.

11. The system of the claim 10, wherein the image includes a license plate of the vehicle.

12. The system of claim 9, further comprising a first mobile device disposed on the first vehicle, and
the first set of data received from the tracking device includes a device ID of the first mobile device, wherein the device ID of the first mobile device is usable to identify the vehicle that the mobile device is disposed on.

13. The system of claim 9, further comprising a mobile device associated with a law enforcement agent, said mobile device being communicatively coupled with the processor and configured to identify whether a vehicle that is parked in the first parking spot is associated with any one of the plurality of users included in the database and whether said identified vehicle is currently paying for parking in the first parking spot.

14. The system of claim 13, wherein the method further includes the steps of:
scanning the first vehicle with the mobile device associated with the law enforcement agent while the first vehicle remains parked in the first spot, and
indicating to the law enforcement agent via the mobile device that the scanned vehicle is currently paying for utilizing the first parking spot.

15. The system of claim 9, the method further comprising:
receiving a first set of data from the second tracking device;
analyzing the first set of data of the second tracking device to determine that a second vehicle from among the plurality of vehicles occupies the second parking spot;
starting to accrue time that the second vehicle occupies the second parking spot;
marking the second vehicle as currently paying for the second parking spot for law enforcement purposes;
receiving a second set of data from the second tracking device and determining based on the second set of data that the second vehicle has departed the second parking spot;
stopping to accrue time for the second vehicle;
determining an amount owed by a user associated with the second vehicle, from among the plurality of users registered with the database, for utilizing the second parking spot for the accrued time; and
billing said user for the determined amount.

16. The system of claim 9, wherein the first and second parking spots are located adjacent to one another.

17. A method for facilitating vehicular-related services, the method comprising:
monitoring data received from a tracking device installed at a vehicular service facility to wirelessly detect a presence of a mobile device in or near a service area of the service facility, the mobile device being associated with a vehicle and a user of the vehicle;
authorizing payment for a service provided by said service area for said vehicle based on the received data;
performing said service;
determining the cost of the performed service; and
billing the user for the determined amount.

18. The method of claim 17, wherein the service is electric vehicle (EV) charging.

19. The method of claim 17, wherein the service is automotive fueling.

20. The method of claim 17, further comprising a step of providing the user with driving directions to said service facility prior to the step of wirelessly detecting the presence of the mobile device adjacent to or near the service area of the service facility.
